(19) United States
(12) Patent Application Publication
(10) Pub. No.: US 2002/0002222 A1
(43) Pub. Date: Jan. 3, 2002

(54) PHOSPHORUS-CONTAINING ANTIOXIDANT STABILIZED AGAINST HYDROLYSIS

(76) Inventors: CHING-FAN CHIU, TAIPEI CITY (TW); KUN-CHANG LEE, TAIPEI CITY (TW); WEN-YI SU, TAINAN CITY (TW); DONG-BI SHIUEH, TAINAN CITY (TW)

Correspondence Address: LADAS & PARRY, 26 WEST 61ST STREET, NEW YORK, NY, 10023, US

(21) Appl. No.: 09/363,284

(22) Filed: Jul. 28, 1999

(51) Int. Cl. C08K 5/49; C07F 9/02

(52) U.S. Cl. 524/120; 558/71

(57) ABSTRACT

An organic phosphorus-containing antioxidant which is stablized against hydrolysis includes (a) 20 to 99.9 wt % of organic phosphite or phosphonite; and (b) 0.1 to 80 wt % of acid-binding metal salt treated with a surface conditioning agent, wherein the weight ratio of the surface conditioning agent to the acid-binding metal salt is 0.1 to 50 wt %:99.9 to 50 wt %, and the surface conditioning agent is selected from the group consisting of silanes, titanates, zirconates, aluminates, zirco-alumiates, non-ionic surfactants, and anionic surfactants.

### FIELD OF THE INVENTION

This invention relates to an organic phosphorus-containing antioxidant stablized against hydrolysis, more particularly to an antioxidant that is useful to enhance the antioxidative property of a resin at a high temperature and high moisture condition.

### BACKGROUND OF THE INVENTION

It is known that phosphorus-containing antioxidants tend to hydrolyze very easily at a high temperature and high moisture condition. Such hydrolysis generates phosphoric acid, thereby further expediting the rate of the hydrolysis. As such, the hydrolysis not only decreases the antioxidative property of the composition, but also causes damages to equipment, and brings about undesirable pollution. In order to solve the disadvantages described above, it is normally proposed to add organic amines in the reaction to decrease the rate of the hydrolysis of the phosphorus-containing antioxidant. Examples of the amines described above are hexamethylene tetramine, triisopropanoyl amine, stearyl dimethyl amine, and the like. However, the improvement is not satisfied, and the presence of the amine will affect the chemical property of the resin and generate poison as well. Therefore, the amine is inappropriate for use. Moreover, organic amines are normally used along with liquid phosphide antioxidant, such as tri-nonyl-phenyl phosphite, di-phenyl-isodecyl phosphite, di-phenyl-isooctyl phosphite, tri-phenyl phosphite, 4,4′-iso-propylidene-diphenol-alkyl (C12-15) phosphite, and the like.

Another method for stabilizing against hydrolysis is to enhance the sterical hindrance of the substitutent at the ortho-position of penolic to hinder water from contacting the phosphorus, thereby effectively preventing the occurrence of hydrolysis. One such example is an antioxidant Irgafos 168 (a trade name, available from Ciba geigy Chemicals Corporation) which is tris(di-tert-butyl-2,4-phenyl) phosphite and which consists of three phenolics substituted at the ortho-position with tertiary butyl substitutents and which has a following formula (I):

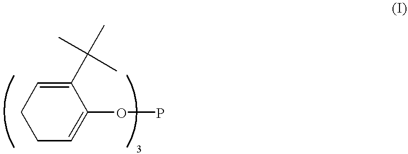

While hydrolysis of the antioxidant of formula (I) can be reduced, however, the composition also reduces the affinity of the phosphorus for oxygen, thereby weakening the antioxidative property. As such, more phosphorus-containing antioxidant has to be added in order to achieve the same property.

To improve the disadvantage described above, U.S. Pat. No. 5,856,550 proposed another method for stabilizing against hydrolysis by adding inorganic acid-binding agent into the phosphorus-containing antioxidant in combination with the amines to achieve the purpose for stabilizing against hydrolysis. Examples of the inorganic acid-binding agent are metal oxide, metal carbonate, metal carboxylate, hydrotalcite, zeolite, and the like. By using the inorganic acid-binding agent in combination with triisopropanyl amine to absorb the phosphoric acid generated from the hydrolysis of the phosphorus-containing antioxidant, the rate of the hydrolysis in an acid condition can be deterred. However, since the affinity of the inorganic acid-binding agent for the organic phosphorus compounds is weak, poor stabilization of the phosphorus-containing antioxidant results when the agent is non-uniformly distributed. Moreover, the addition of organic amines will result in problems, such as initial color of the resin, thermal stability during processing, and generating toxic gas.

U.S. Pat. No. 4,810,579 and 5,326,803 disclose the use of reactive coupling agent for encapsulating the surface of the organic phosphorus compounds, thereby utilizing the hydrophobic characteristic of the coupling agent for water to achieve the purpose of stabilizing against hydrolysis. While the methods described above may be useful for powdered organic phosphorus compounds stored in a high atmospheric humidity, they are still insufficient to effectively stabilize against hydrolysis when they are subjected to a high humidity condition with a temperature above 200° C. For example, in case of blending the organic phosphorus compounds with the resin and then extruding from an extruder at a high humidity and a high temperature (above 100° C.), the stability to hydrolysis can not be achieved with the above described methods.

### SUMMARY OF THE INVENTION

Therefore it is proposed to overcome the problems described above by modifying the composition of the organic phosphorus-containing antioxidant so as to render the same to exhibit good stability to hydrolysis when it is subjected to a high temperature and a high humidity condition.

Therefore, it is an object of this invention to provide an organic phosphorus-containing antioxidant which exhibits good stability to hydrolysis, and which results in good initial color of the resin composition, and which enhances thermal stability during processing and eliminates the generation of toxic gas.

It is another object of this invention to provide an organic phosphorus-containing antioxidant which is capable of enhancing the processability and stability to hydrolysis of resins which are blended with the former, and which can further comprise a carrier and then added directly to the resins.

Thus, this invention is characterized by an organic phosphorus-containing antioxidant comprising: an organic phosphite or organic phosphonite; and an acid-binding metal salt treated with a surface conditioning agent. A carrier can be further included as needed to form an antioxidant which exhibits excellent stability to hydrolysis and antioxidative property when it is subjected to a high temperature and a high atmospheric humidity condition. The above described antioxidant can be used as additives for polymers.

### DETAILED DESCRIPTION OF THE PREFERRED EMBODIMENTS

The organic phosphorus-containing antioxidant of this invention comprises: (a) 20 to 99.9% by weight of organic phosphite or phosphonite; and (b) 0.1 to 80% by weight of acid-binding metal salt treated with a surface conditioning agent, wherein the weight ratio of the surface conditioning agent to the acid-binding metal salt is 0.1 to 50% : 99.9 to 50%, and the surface conditioning agent is selected from the group consisting of silane coupling agents, titanate coupling agents, zirconate coupling agents, aluminate coupling agents, zirco-aluminate coupling agents, non-ionic surfactants, and anionic surfactants.

The phosphite of this invention is represented by the formula P(OR)₃, wherein the substitutents R represent hydrocarbon radicals which may contain hetero atoms, and at most two of the three substitutents R may be hydrogen atoms. The hetero atoms can be all atoms except carbon atoms and hydrogen atoms, preferably N, O, F, Si, P, S, Cl, Br, Sn and I.

The phosphonites are esters of phosphorus acid, and are represented by the formula P(OR)₂R, wherein R has the same meanings described above, or may be halogen. The phosphites or phosphonites of this invention are preferably a solid at 20° C., and are usually a crystalline solid.

Examples of the phosphites of this invention are tri(dimethylphenyl)phosphite, tri(t-octylphenyl)phosphite, tri(nonylphenyl)phosphite (ab. TNPP), tri(docosanylphenyl)phosphite, monobutyl-dioctyl phosphite, tribenzyl phosphite, monobutyl-diphenyl phosphite, mono-nonylphenyl-dioctyl phosphite, monohexyl-diisopropyl phosphite, cyclohexyl-dioctadecyl phosphite, diphenyl-neopentyl diphosphite, diisooctyl-octylphenyl phosphite, tetrakis(nonylphenyl)propylene glycol diphosphite, heptakis(dipropylene glycol)triphosphite, poly(dipropylene glycol)phenyl phosphite, bis-stearyl pentaerythritol diphosphite (ab. BSPDP), 2,2-dimethylpropanol diphosphite, dilauryl hydrogen phosphite, dioctyl hydrogen phosphite, dioctadecyl hydrogen phosphite, trimethylol propane phosphite, 2,2-dimethyl-1,3-propylene lauryl phosphite, triphenyl phosphite, tricyclohexyl phosphite, triethyl phosphite, trioctyl phosphite, trihexyl phosphite, tridodecyl phosphite, trioctadecyl phosphite, triisopropyl phosphite, tri-tertiary butyl phosphite, tri-2-ethylhexyl phosphite, tricresyl phosphite, diphenyl 2-ethylhexyl phosphite, triphenyl phosphite, tris(2,5-di-tert-butylphenyl)phosphite- tris(2-tert-butylphenyl)phosphite, tris(2-phenylphenyl)phosphite. tris(2-(1,1-dimethyl)phenyl)phosphite, tris(2-cyclohexylphenyl)phosphite, tris(2-tert-butyl-4-phenylphenyl)phosphite, tris(2-tert-butyl-4-methylphenyl)phosphite, tris(2,4-di-tert-amylphenyl)phosphite , tris(2,4-di-tert-butylphenyl)phosphite, bis(2,4-di-tert-butylphenyl)pentaerythritol diphosphite, bis-stearyl pentaerythritol diphosphite, tri(mixedmono- and dinonylphenyl)phosphite, 4,4′-isopropylidene-diphenol alkyl (C₁₂-C₁₅)phosphite, diphenyl isodecyl phosphite, and diphenyl isooctyl phosphite.

Examples of the phosphonites of this invention are phenyl diethyl phosphonite, octyl dibutyl phosphonite, decyl diisopropyl phosphonite, hexyl di-tertiary butyl phosphonite, dodecyl dioctyl phosphonite, cyclohexyl dioctadecyl phosphonite, lauryl diphenyl phosphonite, phenyl dicyclohexyl phosphonite, nonylphenyl di-nonylphenyl phosphonite, stearyl di-benzyl phosphonite, and dioctyl neopentyl di-phosphite.

Examples of the acid-binding metal salts of this invention are carbonate, bicarbonate, carboxylate, oxide, hydrooxide, phosphite, borate, hydrotalcite, zeolite, and mixtures thereof. Examples of the above described metal are selected from group IA, IIA, III A, IVA, or rare earth of the periodic table. Examples of the above described acid-binding metal salts are aluminum oxide (Al₂O₃), talc, hydrotalcite, zeolite, silica, montmorillonite, bentonite, MgO, CaO, rare earth oxides, Mg(OH)₂, Ca(OH)₂, Ca₂O₃, calcium acetate, and aluminum magnesium borate, preferably zeolite and hydrotalcite, and most preferably zeolite-containing acid-binding metal salts.

Suitable zeolite of this invention are those having the following formula (II):

XM^{N}[x(AlO₂).y(SiO₂)].w(H₂O) (II)

wherein N is the cation valency of M, M is a metal selected from group IA or IIA of the periodic table, particularly from sodium, potassium, magnesium and/or calcium. The y/x is a number between 0.8 to 1.2, and w is a number between 0.5 to 50.

Examples of the suitable zeolite are those having the following empirical formula:

12Na[12(AlO₂).12(SiO₂)].12(H₂O)

4.5Ca.3Na[12(AlO₂).12(SiO₂)].30(H₂O)

9K.3Na[12(AlO₂).12(SiO₂)].27(H₂O)

Suitable types of zeolite of this invention are A, X, Y, L, ZSM5, 11, 22, and 23 types of Mordenite, Offretite, gray cross zeolite, sodalite, organic zeolite, and ALPO or SAPO substances, preferably A, X, Y types zeolite, more preferably A types zeolite.

The acid-binding metal salt treated with the surface conditioning agent is dispersed in the organic phospite or phosphonite with a particle size less than 50 μm, preferably less than 20 μm, more preferably less than 2 μm. If the particle size of the acid-binding metal salts is greater than 100 μm, the stability to hydrolysis will be poor, especially at a high temperature and a high atmospheric humidity condition.

The hydrotalcite used in this invention are those having the following formula (III):

(1−x)M⁽²⁺⁾.xM⁽³⁺⁾.2(OH).(x/n)A⁽ⁿ⁻⁾.pH²O (III)

wherein M⁽²⁺⁾represents Mg, Ca, Cs, Ba, Zn, Pb, and/or Ni. M⁽³⁺⁾represents Al, B, or Bi. A⁽ⁿ⁻⁾is the anion valency, n is a number from 1 to 4, x is a number from 0 to 0.5, and p is a number from 0 to 2. The A can be OH⁻, Cl⁻, Br⁻, I⁻, ClO₄⁻, HCO₃⁻, CH₃COO⁻, C₆H₅COO⁻, CO₃⁻², SO₄⁻², (CHOHCOO)₂⁻², (CHOH)₄CH₂OHCOO⁻, C₂H₄(COO)₂²⁻, (CH₂COO)₂⁻², CH₃CHOHCOO⁻, SiO₃⁻², SiO₄⁻⁴, Fe (CN)₆⁻³, Fe (CN)₆⁻⁴, BO₃⁻³, PO₃⁻³, or HPO₄⁻².

Other hydrotalcite which can be used conveniently in this invention are those having the following formula (IIIa):

xM⁽²⁺⁾.Al₂.(2x+6nz)(OH).2A⁽ⁿ⁻⁾.pH₂O (IIIa)

wherein M(²⁺⁾ of formula (IIIa) is selected at least from one of the metal group similar to Mg or Zn, preferably Mg. The A⁽ⁿ⁻⁾ is an anion, particularly selected from CO₃²⁻ and S₂⁻, the valency of the above described anion is n, p is a number, preferably from 0.5 to 5, x and z are both integers, x is preferably from 2 to 6, and z is preferably smaller than 2.

Preferable hydrolcites of this invention are those compounds having formula (III), wherein M⁽²⁺⁾ is Ca or Mg, or solid solution of Mg or Zn, the A⁽ⁿ⁻⁾ is CO₃²⁻, BO₃⁽³⁻⁾, or PO₃⁽³⁻⁾, x is a number from 0 to 0.5, p is a number from 0 to 2, and the M⁽³⁺⁾ of these metal salts is preferably an aluminum ion.

Results from experiments show that the hydrolcites particularly suitable for this invention are those of compounds with the following formulas:

Al₂O₃.6MgO.CO₂.12H₂O (III b),

4.5Mg. Al₂(OH)₁₃.CO₃.3.5H₂O (III c)

4MgO.Al₂O₃.2CO₂.9H₂O (III d),

4MgO.Al₂O₃.2CO₂.6H₂O (III e),

ZnO.MgO.Al₂O₃.CO₂.8-9H₂O (III f),

or

ZnO.3MgO.Al₂O₃.CO₂.5-6H₂O (III g)

The surface conditioning agent of this invention is selected from the group consisting of silane coupling agents, titanate coupling agents, zirconate coupling agents, aluminate coupling agents, zirco-aluminate coupling agents, non-ionic surfactants, and anionic surfactants, preferably silane coupling agents and non-ionic surfactants, most preferably silane coupling agent. Examples of titanate coupling agents are isopropyl triso stearoyl titanate, isopropyl tris(dioctyl pyrophosphate)titanate, bisdioctyl(pyrophosphate) oxyacetate titanate, bisoctyl(pyrophosphate)ethylene titanate, tetraisopropyl bis(dioctyl phosphite)titanate, and tetra octyl bis(di(tridecyl phosphite))titanate.

Specific examples of the silane coupling agents are γ-aminopropyl trimethoxy silane, γ-aminopropyl triethoxy silane, γ-aminopropyl methyl diethoxy silane, N-β-aminoethyl-γ-aminopropyl trimethoxy silane, N-β-aminoethyl-γ-aminopropyl methyl dimethoxy silane, 4,5-dihydro-1-[3-(triethoxysilyl)propyl]imidazole, γ-mercaptopropyl trimethoxy silane, γ-mercaptopropyl methyldimethoxy silane, γ-glycidyloxypropyl trimethoxy silane, γ-methacryloxypropyl trimethoxy silane, γ-chloropropyl trimethoxy silane, γ-chloropropyl triethoxy silane, γ-chloropropyl methyl dimethoxy silane, vinyl trimethoxy silane, vinyl triethoxy silane, and vinyl tris(β-methoxy ethoxy)silane, preferably vinyl trimethoxy silane and the like.

Specific examples of the non-ionic surfactants are propylene glycol stearate, di-stearo-propylene glycol, di-ethylene glycol-mono-stearate, sesqui-oleo-sorbitant, tri-stearo-sorbitant, mono-palmito-polyethylene glycol, polyethylene glycol, polypropyleneglycol, di-stearo-polyethylene glycol, di-oleo-polyethylene glycol, lano fatty acid polyethylene glycol, tri-stearoamide polyoxyethylene sorbitant, polyoxyehtylene lano ether alcohol, polyoxyethylene coconut fatty acid amide, polyoxyethylene polypropylene glycol, polyoxyethylene alkyl ether, polyoxyethylene polyoxypropylene alkyl ether, coconut fatty acid mono-ehtanolamide, stearo-ehtanolamide, and stearo-di-ehtanolamide, polyoxyethylene phenyl ether (the hydrogen atom of the benzene ring can be substituted with groups such as isobutyl or octyl group), polyoxyehtylene octyl phenyl ether, and the like, preferably polyoxyethylene alkyl ether, polyoxyethylene polyoxypropylene alkyl ether, and polyoxyethylene phenyl ether.

Specific examples of anionic surfactants are alkyl sodium sulfate, polyoxyethylene alkyl ether sodium sulfate, polyoxyethylene alkyl phenyl ether sodium sulfate, phosphoric polyoxyethylene alkyl ether, phosphoric polyoxyethylene alkyl phenyl ether, phosphoric triethanoamine polyoxyethylene alkyl phenyl ether, and lecithin.

The total amount of the above described surface conditioning agent and the acid-binding metal salt is 100% by weight. The weight ratio of the surface conditioning agent to the acid-binding metal salt is in the range of 0.1 to 50% : 99.5 to 50%, preferably 2 to 25% 98 to 75%. When the weight ratio of the surface conditioning agent to the acid-binding metal salt is below 0.1 : 99.9, the dispersion of the acid-binding metal salt in the organic phosphorous containing antioxidant and the stability to hydrolysis will be poor. When the weight ratio for these two compounds is above 50:50, it will become uneconomical.

The process for the preparation of the acid-binding metal salt treated with the surface conditioning agent is to place the acid-binding metal salt, such as zeolite, hydrolcite and the like, with the surface conditioning agent into a closed mixer to uniformly mix them together to ensure an encapsulation occuring on the surface of the zeolite or the hydrolcite. In another method, the zeolite or the hydrolcite is slurried by mixing with a solvent, and is subsequently mixed uniformly with the surface conditioning agent. This mixture is then dried to eliminate the solvent. The operating condition for this method is desirable to be below 100° C.

The organic phosphorus-containing antioxidant stablized against hydrolysis of this invention can further comprise a carrier. The incorporation of the carrier can be accomplished by pressing, extrusion or pelletizing. Basically, there is no limitation for the carrier to be used in this invention, except for the processability of the resin, preferably for those organic compounds which exhibit a higher melting point than the organic phosphorus-containing antioxidant. Examples of these compounds are polypropylene waxes, polyethlene waxes, ethylene bis-stearamide (EBA), lubricant, processing aids, and primary antioxidant (ex: phenolics) or secondary antioxidant (ex: sulfur, phosphorus, sterically hindered amines), such as tetra kis methylene-3-(3′,5′-di-tert-butyl-4-hydroxyphenyl) propionate methane or tris-(di-tert-butyl-2,4-phenyl)phosphite. The amount of the above described carrier to be added is about 0 to 200 parts per 100 parts of the antioxidant, and preferably about 25 to 150 parts.

Another object of this invention is to add an organic polymer into the organic phosphorus-containing antioxidant which has been stablized against hydrolysis, so as to produce a thermoplastic resin composition which possesses good stability to hydrolysis, better initial color, and excellent thermal stability during processing. Examples of the above described organic polymers are ethylenic polymer, styrenic polymer, diene polymer, polycarbonate, polyester, and mixtures thereof, wherein the ethylenic polymer are those compounds such as polypropylene(PP), polyethylene(PE), polyvinyl chloride(PVC), and polymehtylmethacrylate(PMMA). The styrenic polymer are those compounds such as polystyrene(PS), high impact polystyrene(HIPS), acrylonitrile-butadiene-styrene (ABS) copolymer, acrylonitrile-styrene (AS) copolymer, methylmethacrylate-butadiene-styrene (MBS) copolymer, acrylate-acrylonitrile-styrene (AAS) copolymer, and ehtylene-propylene-diene-rubber-acrylonitrile-styrene (AES) copolymer. The diene polymer are those compounds, such as homopolymers or copolymers of butadiene, isopentadiene and chlorobutadiene. The polyester are those compounds such as polyethylene terephthalate (PET) and polybutylene glycol terephthalate (PBT).

The organic polymer of this invention for extrusion contains greater than 2% water. The thermoplastic resin composition can be obtained by adding suitable amount of the carrier into the above described organic polymer with the stabilized organic phosphite or phosphonite in a predetermined ratio, and then the mixture is extruded to form pellets by an extruder which is provided with a devaporlization device. The operating temperature of the above described extruder is adjusted at a temperature of 180 to 300° C. The above described organic polymer emulsion can be obtained by agglomerating, and is subsequently dewatered via a centrifugal dewater device to form a polymer powder with about 30% of water. In order to simplify the operating steps for the drying operation, the above described 30% water containing polymer powder is normally added directly with the carrier and other polymers, and is subsequently dewatered to form a polymer product with a water content of below 0.5.

The stabilized organic phosphorus-containing oxidant of this invention is particularly suitable for use in resin processing at a high temperature and a high atmospheric humidity condition, more particularly for compounding and extruding at a temperature above 180° C. At such operating condition, the hydrolysis of the phosphorus-containing antioxidant is little. In addition, excellent initial color and thermal stability of the resin are also obtained.

The following examples illustrate the praticability of this invention, and are not intended to limit the scope of this invention and the appended claims.

### EXAMPLES

### Case 1 stability to hydrolysis test)

Since the pH value will decrease in view of the generation of the phosphorus acid from the hydrolysis, the rate of the hydrolysis can be obtained by measuring the variation of the pH value.

A one-liter flask is provided with a thermometer, a mechanical stirrer, a condenser, and a pH meter. Successively, 450 g of the deionized water and 50.0 g (0.100 mole) of tri(nonylphenyl)phosphite (TNPP used as the phosphite compound) with the aluminum oxide or zeolite (used as the acid-binding metal salt) which has been treated with silanes as a surface conditioning agent was introduced into the flask. The stirrer is started, and the mixture is heated to a predetermined temperature of 80° C. by a heater. The pH value is recorded every hour.

As shown in Table 1, the weight ratio of the silane to the aluminum oxide is 1:10, and that of the silane to the A type zeolite is also 1:10. The average particle size is 0.5 μm.

TABLE 1

| | Comparative | | |
|---|---|---|---|
| Composition | Example 1 | Example 1 | Example 2 |
| TNPP | 50 | 50 | 50 |
| Deionized water | 450 | 450 | 450 |
| Aluminum oxide^{(*)} | — | 2.75 | — |
| Zeolite^{(*)} | | — | 2.75 |
| Stability against hydrolysis | X | O | O |

^{(*)}which is treated with silanes as the surface conditioning agent.

The symbol “X” indicates poor stability to hydrolysis, and symbol “O” indicates good stability to hydrolysis.

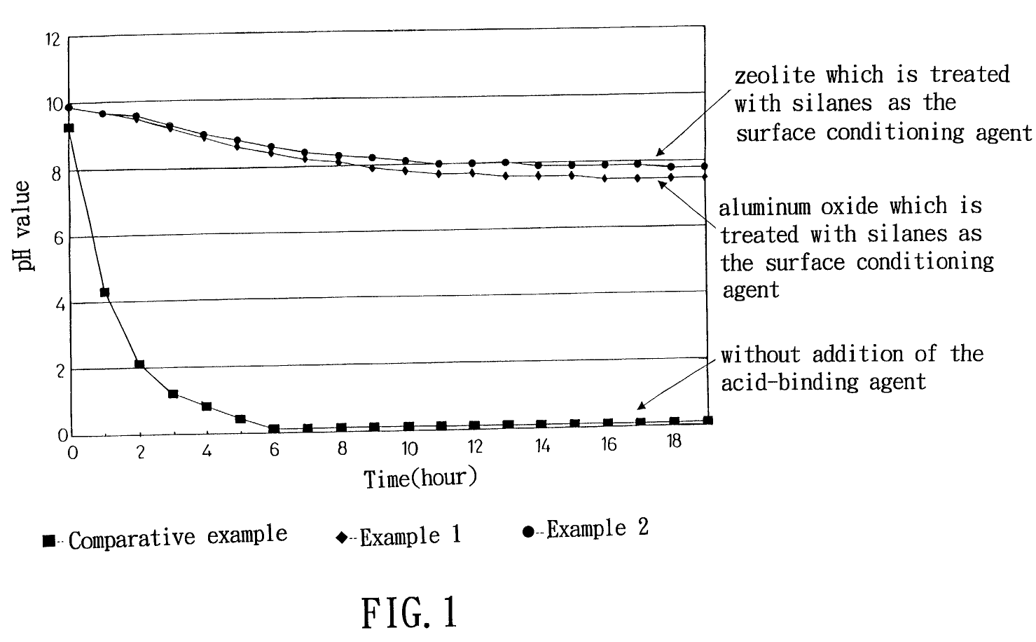

The variation of the pH value is illustrated in FIG. 1. The curve shown in FIG. 1 indicates that the composition of the antioxidant of this invention is capable of effectively deferring the rate of hydrolysis.

### Case 2

Bis-stearyl pentaerythritol diphosphite (BSPDP) is used as the phosphite compound and was uniformly mixed with different acid-binding agents and Irganox 1010 (used as the carrier) according to the composition shown in Table 2. The mixture is subsequently heated and extruded to form into pellets. The resulting products are ready for a physical property test. A one-liter flask which is similar to Example 1 is provided with a temperature controller, a mechanical stirrer, a condenser, and a pH meter. Five hundreds grams of deionized water is introduced into the flask, and is heated to and sustained at a temperature of 100° C. Afterwards, 10 g of the products to be tested are added into the flask. The initial pH value (0 min) is recorded, and is then recorded every 15 mins. The results are shown in Table 3.

TABLE 2

| Types of | | | | | | | | | |
|---|---|---|---|---|---|---|---|---|---|
| antioxidant | A | B | C | D | E | F | G | H | I |
| BSPDP | 40 | 40 | 40 | 40 | 40 | 100 | 50 | 0 | 50 |
| Irganox 1010⁽¹⁾ | 40 | 40 | 40 | 40 | 40 | 0 | 50 | 0 | 0 |
| Irgafos168⁽²⁾ | | | | | | | | 100 | |
| DHT-4A-2⁽*³⁾ | | | | 20 | | | | | |
| x type zeolite⁽*⁾ | | | | | 20 | | | | |
| A type zeolite^{(#4)} | 20 | | | | | | | | |
| DHT-4A-2^{(#)} | | 20 | | | | | | | |
| MgO + DHT-4A-2^{(#5)} | | | 20 | | | | | | |
| EBA⁽**⁶) | | | | | | | | | 50 |

⁽*⁾not treated with silanes.
^{(#)}treated with silanes.
⁽**⁾lubricant.
⁽¹⁾irganox 1010 is a trade name and is available from Ciba geigy Chemicals Corporation. Its chemical name is tetra kis methylene-3-(3′, 5′-di-tert-butyl-4-hydroxyphenyl) propionate methane.
⁽²⁾Irgafos 168 is a trade name and is available from Ciba geigy Chemicals Corporation. Its chemical name is tris(di-tert-butyl-2,4-phenyl) phosphite.
⁽³⁾DHT-4A-2 is available from Kyowa company. Its chemical name is 4.5Mg · Al₂(OH)₁₃ · CO₃ · 3.5H₂O.
⁽⁴⁾A type zeolite treated with silane has a ratio of silane to A type zeolite of about 2:18. Its weight average particle size is 0.5 μm.
⁽⁵⁾MgO and DHT-4A-2 are mixed and surface treated with

⁽¹⁾ Irganox 1010 is a trade name and is available from Ciba geigy Chemicals Corporation. Its chemical name is tetra kis methylene-3-(3′,5′-di-tert-butyl-4-hydroxyphenyl) propionate methane. ⁽²⁾ Irgafos 168 is a trade name and is available from Ciba geigy Chemicals Corporation. Its chemical name is tris(di-tert-butyl-2,4-phenyl) phosphite. ⁽³⁾ DHT-4A-2 is available from Kyowa company. Its chemical name is 4.5 Mg . Al₂ (OH)₁₃. CO₃. 3.5H₂O. ⁽⁴⁾ A type zeolite treated with silane has a ratio of silane to A type zeolite of about 2:18. Its weight average particle size is 0.5 μm. ⁽⁵⁾ MgO and DHT-4A-2 are mixed and surface treated with hydrotalcite. The ratio of MgO plus DHT-4A-2 to silane is 17:3. MgO is available from Kyowa company and has a trade name Kyowaway 150. ⁽⁶⁾ EBA is ethylene bis-stearamide.

TABLE 3

| | | | Comp. | Comp. | Comp. | Comp. |
|---|---|---|---|---|---|---|
| | Exam- | Exam- | Exam- | Exam- | Exam- | Exam- |
| Sample number | ple 3 | ple 4 | ple 2 | ple 3 | ple 4 | ple 5 |
| Types of | A | C | D | E | F | G |
| antioxidant | | | | | | |

measured pH value

| | | | | | | |
|---|---|---|---|---|---|---|
| 0 min | 7.8 | 8.0 | 3.6 | 5.4 | 2.5 | 6.5 |
| 15 min | 7.6 | 7.3 | 4.0 | 5.0 | 1.7 | 2.3 |
| 30 min | 7.3 | 6.9 | 3.4 | 4.0 | 1.6 | 2.1 |
| 45 min | 7.0 | 6.2 | 3.0 | 3.8 | 1.5 | 1.6 |
| Stability to | O | O | X | X | X | X |
| hydrolysis | | | | | | |

The stability to hydrolysis is better when the variation of the pH value as described above is smaller and the pH value is higher. The composition of the antioxidant of this invention (Examples 3 and 4) exhibits good stability to hydrolysis. Comparative Example 2 employed DHT-4A-2 type hydrotalcite. However, since such hydrotalcite has not been treated with the silane, the stability to hydrolysis is thus poor. Comparative Example 3 employed the X type zeolite which has not been treated with silane. Due to large particle size (average particle size is 60 μm), the mixing of the BSPDP and the Irganox 1010 is poor, thereby resulting in poor stability to hydrolysis. Comparative Example 4 employed only BSPDP without addition of the acid-binding agent. Comparative Example 5 employed both the BSPDP and the Irganox 1010 without addition of the acid-binding agent. Both Examples are also poor in the stability to hydrolysis.

### Case 3

The measuring standard for the stability to hydrolysis of the composition of this invention in a resin is based on yellow index (YI) value. In order to demonstrate the excellent stability to hydrolysis and antioxidative property of the composition of this invention, the ABS polymer with 30% water, ABS polymer with less than 0.5% water, and the AS polymer are employed separately and each of which is added with the antioxidant and the lubricant as listed in Table 4. These polymer are then pelletized by extrusion by using a Germany W&P ZSK-25 extruder at a temperature of 230° C. It is desirable to devaporlization during the extrusion of the ABS polymer. The pellets of these polymer are extruded separately, via a Taiwan 40Z SM-90 extruder, at a temperature of 210° C., into discs with the same diameter of 55 mm and thickness of 3.2 mm. These discs are placed and cooled, and are subsequently analyzed for their YI value via a Gretoawacbeth color-eye 3100 spectrometer. After the analysis, these discs were placed into a rotatable tray-type oven for heating for two hours at a temperature of 180° C., and were subsequently cooled and analyzed for the YI value. The difference between the YI values before and after the heating in the oven is ΔYI. The smaller the YI and the ΔYI, the better will be the stability to hydrolysis.

TABLE 4

| | |
|---|---|
| Examples | Comparative Examples |

| Samples No. | 5 | 6 | 7 | 8 | 6 | 7 | 8 | 9 | 10 |
|---|---|---|---|---|---|---|---|---|---|
| ABS-1⁽*⁾ | | | 30 | 30 | | | | | |
| ABS-2^{(#)} | 30 | 30 | | | 30 | 30 | 30 | 30 | 30 |
| AS | 70 | 70 | 70 | 70 | 70 | 70 | 70 | 70 | 70 |
| EBA⁽**⁾ | 2 | 2 | 2 | 2 | 2 | 2 | 2 | 2 | 2 |
| Antioxidant | | | | | | | | | |
| Types | A | B | A | B | E | F | G | H | I |
| Parts | 0.15 | 0.15 | 0.15 | 0.15 | 0.15 | 0.15 | 0.15 | 0.15 | 0.15 |
| YI value | | | | | | | | | |
| YI | 12 | 13 | 11.5 | 12.4 | 15.2 | 18 | 16 | 17 | 19 |
| ΔYI | 30 | 30 | 29 | 28 | 36 | 39 | 38 | 36 | 40 |

^{(*)}ABS-1 is acrylonitrile-butadiene-styrene copolymer (dry powder) with less than 0.5% by dry weight of water.
^{(#)}ABS2 is acrylonitrile-butadiene-styrene copolymer (wet powder) with 30% by dry weight of water.
^{(**)}EBA is ethylene bis-stearamide.

The Examples shown in Table 4 indicate that the phosphorus-containing antioxidant lost its antioxidative property after being hydrolyzed. The values of the YI and the ΔYI of the composition of the antioxidant of this invention are better than those of the Comparative Examples, thereby increasing the antioxidative property of the resins, preventing the phosphite compounds from hydrolyzing, and exhibiting higher softening point. The antioxidative property of the antioxidant of this invention is also synergistically enhanced, and is useful for the industry.

The description described above only illustrates those preferred embodiments, and it is not intended to limit this invention to these embodiments. It is apparent that various modifications and variations without departing from the spirit of the present invention are included within the scope of this invention.

We claim:

1. A stabilized organic phosphorus-containing antioxidant comprising:
(a) 20 to 99.9 wt % of organic phosphite or phosphonite; and
(b) 0.1 to 80 wt % of acid-binding metal salt treated with a surface conditioning agent,
wherein the weight ratio of said surface conditioning agent to said acid-binding metal salt is 0.1 to 50 wt %:99.9 to 50 wt %, and said surface conditioning agent is selected from the group consisting of silane coupling agents, titanate coupling agents, zirconate coupling agents, aluminate coupling agents, zirco-aluminate coupling agents, non-ionic surfactants, and anionic surfactants.

2. The stabilized organic phosphorus-containing antioxidant of claim 1, wherein said surface conditioning agent is silane coupling agent.

3. The stabilized organic phosphorus-containing antioxidant of claim 2, wherein said silane coupling agent is selected from the group consisting of γ-aminopropyl trimethoxy silane, γ-aminopropyl triethoxy silane, γ-aminopropyl methyl diethoxy silane, N-β-aminoethyl-γ-aminopropyl trimethoxy silane, N-β-aminoethyl-γ-aminopropyl methyl dimethoxy silane, 4,5-dihydro-1-[3-(triethoxysilyl)propyl]imidazole, γ-mercaptopropyl trimethoxy silane, γ-mercaptopropyl methyldimethoxy silane, γ-glycidyloxypropyl trimethoxy silane, γ-methacryloxypropyl trimethoxy silane, γ-chloropropyl trimethoxy silane, γ-chloropropyl triethoxy silane, γ-chloropropyl methyl dimethoxy silane, vinyl trimethoxy silane, vinyl triethoxy silane, and vinyl tris(β-methoxy ethoxy)silane.

4. The stabilized organic phosphorus-containing antioxidant of claim 3, wherein said silane coupling agent is selected from vinyl trimethoxy silane and vinyl triethoxy silane.

5. The stabilized organic phosphorus-containing antioxidant of claim 1, wherein said surface conditioning agent is a non-ionic surfactant.

6. The stabilized organic phosphorus-containing antioxidant of claim 5, wherein said non-ionic surfactant is selected from the group consisting of propylene glycol stearate, di-stearopropylene glycol, di-ethylene glycol-mono-stearate, sesquioleosorbitant, tri-stearosorbitant, mono-palmitopolyethylene glycol, polyethylene glycol, polypropylene glycol, di-stearopolyethylene glycol, di-oleopolyethylene glycol, lano fatty acid polyethylene glycol, tri-stearoamide polyoxyethylene sorbitant, polyoxyethylene lano ether alcohol, polyoxyethylene coconut fatty acid amide, polyoxyethylene polypropylene glycol, polyoxyethylene alkyl ether, polyoxyethylene polyoxypropylene alkyl ether, coconut fatty acid mono-ethanolamide, stearoethanolamide, and stearo-di-ethanolamide, polyoxyethylene phenyl ether (the hydrogen atom of the benzene ring can be substituted with groups such as isobutyl or octyl group), and polyoxyethylene octyl phenyl ether.

7. The stabilized organic phosphorus-containing antioxidant of claim 6, wherein said non-ionic surfactant is selected from polyoxyethylene alkyl ether, polyoxyethylene polyoxypropylene alkyl ether, and polyoxyethylene phenyl ether.

8. The stabilized organic phosphorus-containing antioxidant of claim 1, wherein said acid-binding metal salt is selected from the group consisting of metal of carbonate, bicarbonate, carboxylate, oxide, hydrooxide, phosphite and borate, hydrotalcite, zeolite, and mixtures thereof, said metal is selected from the group IA, IIA, IIIA, IVA, or rare earth of the periodic table.

9. The stabilized organic phosphorus-containing antioxidant of claim 8, wherein said acid-binding metal salt is a hydrotalcite.

10. The stabilized organic phosphorus-containing antioxidant of claim 8, wherein said acid-binding metal salts is a zeolite.

11. The stabilized organic phosphorus-containing antioxidant of claim 10, wherein said acid-binding metal salt is A type zeolite.

12. The stabilized organic phosphorus-containing antioxidant of claim 1, wherein the weight ratio of said surface conditioning agent to said acid-binding metal salt is 2 to 25 wt %:98 to 75 wt %.

13. The stabilized organic phosphorus-containing antioxidant of claim 1, wherein the average particle size of said acid-binding metal salt which is treated with said surface conditioning agent and which is dispersed in said phosphite or phosphonite is below 50 μm.

14. The stabilized organic phosphorus-containing antioxidant of claim 13, wherein the average particle size of said acid-binding metal salt which is treated with said surface conditioning agent is below 20 μm.

15. The stabilized organic phosphorus-containing antioxidant of claim 13, wherein the average particle size of said acid-binding metal salt which is treated with said surface conditioning agent is below 2 μm.

16. The stabilized organic phosphorus-containing antioxidant of claim 1, further comprising a carrier.

17. A thermoplastic resin composition comprising an organic polymer and a stabilized organic phosphorus-containing antioxidant, said antioxidant comprising:
(a) 20 to 99.9 wt % of organic phosphite or phosphonite; and
(b) 0.1 to 80 wt % of acid-binding metal salt treated with a surface conditioning agent,
wherein the weight ratio of said surface conditioning agent to said acid-binding metal salt is 0.1 to 50 wt %:99.9 to 50 wt %, and said surface conditioning agent is selected from the group consisting of silane coupling agents, titanate coupling agents, zirconate coupling agents, aluminate coupling agents, zirco-aluminate coupling agents, non-ionic surfactants, and anionic surfactants.

18. The thermoplastic resin composition of claim 17, wherein said organic polymer is selected from the group consisting of ethylenic polymer, styrenic polymer, diene polymer, polycarbonate, polyester, and mixtures thereof.

19. The thermoplastic resin composition of claim 17, wherein said organic phosphorus-containing antioxidant further comprises a carrier.

20. A process for producing thermoplastic resin composition comprising compounding and extruding, via an extruder, a mixture of an organic polymer having a water content greater than 2% and an organic phosphorus-containing antioxidant, wherein said organic phosphorus-containing antioxidant comprises:
(a) 20 to 99.9 wt % of organic phosphite or phosphonite; and
(b) 0.1 to 80 wt % of acid-binding metal salt treated with a surface conditioning agent, wherein the weight ratio of said surface conditioning agent to said acid-binding metal salt is 0.1 to 50 wt %:99.9 to 50 wt %, and said surface conditioning agent is selected from the group consisting of silane coupling agents, titanate coupling agents, zirconate coupling agents, aluminate coupling agents, zirco-aluminate coupling agents, non-ionic surfactants, and anionic surfactants.

21. The process of claim 20, wherein the water content of said organic polymer is greater than 5 wt %.
